(19) United States
(12) Patent Application Publication
(10) Pub. No.: US 2025/0363328 A1
(43) Pub. Date: Nov. 27, 2025

(54) SUBGRAPH PATTERN EXTRACTION

(71) Applicant: Roku, Inc., San Jose, CA (US)

(72) Inventors: Takanori Maehara, London (GB); Kapil Kumar, London (GB); Abhishek Majumdar, Santa Clara, CA (US); Nitish Aggarwal, Sunnyvale, CA (US)

(21) Appl. No.: 19/215,084

(22) Filed: May 21, 2025

Related U.S. Application Data
(60) Provisional application No. 63/650,336, filed on May 21, 2024.

(51) Int. Cl. G06N 3/042

(52) U.S. Cl. CPC G06N 3/042

(57) ABSTRACT

Aspects of the disclosed technology provide solutions for extracting subgraph patterns in graph-structured data and encoding them as embeddings using a graph neural network (GNN). In some aspects, a process of the disclosed technology can include steps for receiving an input graph comprising a plurality of nodes and edges, the input graph representing relationships among a plurality of entities, parameterizing a graph neural network model based on a set of pattern graphs, and identifying, for at least a portion of the nodes in the input graph, rooted homomorphisms between the pattern graphs and local subgraphs rooted at the respective nodes. Systems and machine-readable media are also provided.

### CROSS-REFERENCE TO RELATED APPLICATIONS

This application claims the benefit of U.S. Application No. 63/650,336, filed May 21, 2024, entitled “SUBGRAPH PATTERN EXTRACTION”, which is incorporated by reference in its entirety.

### BACKGROUND

### Field

This disclosure is generally directed to artificial intelligence (AI), machine learning (ML), and neural networks, and more particularly to neural networks for extracting patterns in graph-structured data.

### SUMMARY

Provided herein are a system, apparatus, article of manufacture, method and/or computer program product embodiments, and/or combinations and sub-combinations thereof, for extracting subgraph patterns in graph-structured data and encoding them as embeddings using a graph neural network (GNN).

In some aspects, a method is provided for receiving, by a processing system, an input graph comprising a plurality of nodes and edges, the input graph representing relationships among a plurality of entities, parameterizing a graph neural network model based on a set of pattern graphs, wherein each pattern graph defines a subgraph pattern of interest, and identifying, for at least a portion of the nodes in the input graph, rooted homomorphisms between the pattern graphs and local subgraphs rooted at the respective nodes, wherein the rooted homomorphisms preserve adjacency relationships of the pattern graphs.

In another aspect, an apparatus is provided, the apparatus comprising: at least one memory; and at least one processor coupled to the at least one memory, the at least one processor configured to perform operations for: receiving, by a processing system, an input graph comprising a plurality of nodes and edges, the input graph representing relationships among a plurality of entities, parameterizing a graph neural network model based on a set of pattern graphs, wherein each pattern graph defines a subgraph pattern of interest, and identifying, for at least a portion of the nodes in the input graph, rooted homomorphisms between the pattern graphs and local subgraphs rooted at the respective nodes, wherein the rooted homomorphisms preserve adjacency relationships of the pattern graphs.

In yet another aspect, a non-transitory computer-readable storage medium is provided. The storage medium can include at least one instruction for causing a computer or processor to: receive an input graph comprising a plurality of nodes and edges, the input graph representing relationships among a plurality of entities, parameterize a graph neural network model based on a set of pattern graphs, wherein each pattern graph defines a subgraph pattern of interest, and identify, for at least a portion of the nodes in the input graph, rooted homomorphisms between the pattern graphs and local subgraphs rooted at the respective nodes, wherein the rooted homomorphisms preserve adjacency relationships of the pattern graphs.

### BRIEF DESCRIPTION OF THE FIGURES

The accompanying drawings are incorporated herein and form a part of the specification.

FIG. 1 illustrates a block diagram of an example multimedia environment, according to some examples of the present disclosure.

FIG. 2 illustrates a block diagram of an example streaming media device, according to some examples of the present disclosure.

FIG. 3 illustrates an example system for extracting subgraph patterns in graph-structured data using a graph neural network (GNN), according to some examples of the present disclosure.

FIG. 4 is a diagram illustrating an example of a GNN architecture, according to some examples of the present disclosure.

FIG. 5 is a diagram illustrating an example of a GNN architecture, according to some examples of the present disclosure.

FIG. 6 is a diagram illustrating an example of a neural network architecture, according to some examples of the present disclosure.

FIG. 7A illustrates an example process for identifying rooted homomorphisms between one or more pattern graphs and one or more local subgraphs, according to some aspects of the disclosed technology.

FIG. 7B illustrates an example process for making a targeted media recommendation using rooted node homeomorphism feature vectors, according to some aspects of the disclosed technology.

FIG. 8 illustrates an example computer system that can be used for implementing various aspects of the present disclosure.

In the drawings, like reference numbers generally indicate identical or similar elements. Additionally, generally, the left-most digit(s) of a reference number identifies the drawing in which the reference number first appears.

### DETAILED DESCRIPTION

A graph neural network (GNN) is a class of neural network models specifically designed to operate on graph-structured data. In various network science domains—such as web graphs, social networks, and biological interaction networks—input data often consists of large, sparse graphs. Within these graphs, recurring small-scale structural motifs, known as subgraph patterns, frequently capture characteristic relationships between entities. Common examples of such patterns include triangles, quadrangles, and cliques, which may reflect clustered connections, co-participation, or tightly coupled interactions among nodes. Conventional graph neural networks (GNNs) are limited in their ability to detect and encode higher-order relationships among entities in graph-structured data, particularly in large, sparse graphs such as those found in media recommendation systems. Traditional message-passing GNNs primarily model pairwise relationships between nodes and lack the expressive power to distinguish complex interaction patterns, such as co-watching behavior among groups of users or sequential viewing of related media items. This limitation arises because standard architectures, like GCNs and GINs, are constrained by the expressive ceiling of the first-order Weisfeiler-Lehman test and thus fail to capture intricate subgraph motifs like cliques, cycles, or clustered structures.

The disclosed technology provides solutions (e.g., a system, method, and computer program product), for extracting subgraph patterns in graph-structured data using a pattern-aware GNN architecture referred to as a Rooted Graph Homomorphism Network (RGHN). The RGHN model is parameterized by a set of rooted pattern graphs (e.g., triangles, quadrangles, cliques) and is designed to efficiently enumerate and aggregate rooted homomorphisms over these patterns. By leveraging these higher-order patterns, the system encodes complex structural relationships among entities—such as user co-engagement clusters or multi-node media affinity patterns—into rich node embeddings.

The system operates in two phases. First, during training, the model processes real-world metadata—such as user-media interactions (e.g., a user_watched_movie relationship), actor co-appearances (e.g., actor_appear-in_movie relationships), and related entity interactions—to generate rooted subgraph embeddings. The embeddings are learned by aggregating feature information along rooted homomorphism mappings from specified pattern graphs into the observed data graph. Second, during inference, the trained model receives updated graph-structured metadata, detects instances of the learned subgraph patterns, and produces updated node embeddings that can be used for downstream tasks including media content recommendation, user similarity clustering, or targeted content ranking.

In some approaches, the RGHN architecture is optimized to run in linear time on large, sparse graphs, particularly graphs with bounded degree or bounded degeneracy, by aggregating information locally over the prescribed subgraph patterns and employing dynamic programming techniques where applicable. For example, in a streaming media environment, the system can efficiently capture patterns such as a user sequentially watching a series of related movies (e.g., Harry Potter 1, Harry Potter 2, etc.)—represented as triangular or square subgraph motifs—or detect clusters of users who have similar viewing histories based on shared content affinities.

Importantly, the expressive power of the RGHN is fully characterized by the homomorphism distinguishability of graphs generated by the selected pattern set P●. This allows the model to outperform traditional message-passing GNNs, which are limited by first-order Weisfeiler-Lehman (1-WL) expressivity, particularly in recognizing complex, higher-order relationships critical for effective recommendation and search tasks.

By extracting and encoding subgraph patterns as embeddings, the disclosed technologies significantly improve subgraph detectability and system scalability. They enable more accurate and expressive representation of user behaviors, content relationships, and actor co-appearances, thereby enhancing the performance and quality of recommendation engines, targeted advertising systems, and media search platforms.

As discussed in further detail below, the technologies and techniques described herein can significantly improve subgraph detectability and scalability. For example, the disclosed technology can provide a scalable framework for large sparse graphs while maintaining the capacity to detect substructures (e.g., subgraph patterns). Further, the technologies and techniques described herein can improve embeddings that encode information such as subgraph pattern information. For example, the disclosed technology can improve the quality of search and recommendation system by utilizing a model that can encode subgraph pattern information into embeddings.

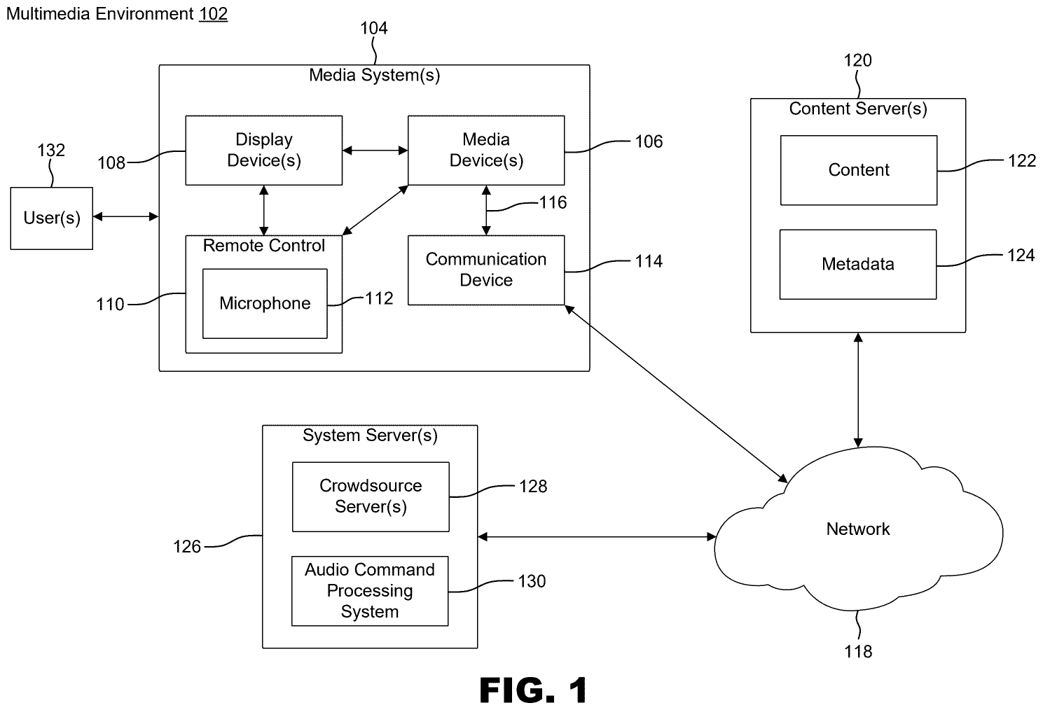

Various embodiments and aspects of this disclosure may be implemented using and/or as part of a multimedia environment 102 shown in FIG. 1. It is noted, however, that multimedia environment 102 is provided solely for illustrative purposes and is not limiting. Examples and embodiments of this disclosure may be implemented using, and/or may be part of, environments different from and/or in addition to the multimedia environment 102, as will be appreciated by persons skilled in the relevant art(s) based on the teachings contained herein. An example of the multimedia environment 102 shall now be described.

### Multimedia Environment

FIG. 1 illustrates a block diagram of a multimedia environment 102, according to some embodiments. In a non-limiting example, multimedia environment 102 may be directed to streaming media. However, this disclosure is applicable to any type of media (instead of or in addition to streaming media), as well as any mechanism, means, protocol, method and/or process for distributing media.

The multimedia environment 102 may include one or more media systems 104. A media system 104 could represent a family room, a kitchen, a backyard, a home theater, a school classroom, a library, a car, a boat, a bus, a plane, a movie theater, a stadium, an auditorium, a park, a bar, a restaurant, or any other location or space where it is desired to receive and play streaming content. User(s) 132 may operate with the media system 104 to select and consume content.

Each media system 104 may include one or more media devices 106 each coupled to one or more display devices 108. It is noted that terms such as “coupled,” “connected to,” “attached,” “linked,” “combined” and similar terms may refer to physical, electrical, magnetic, logical, etc., connections, unless otherwise specified herein.

Media device 106 may be a streaming media device, DVD or BLU-RAY device, audio/video playback device, cable box, and/or digital video recording device, to name just a few examples. Display device 108 may be a monitor, television (TV), computer, smart phone, tablet, wearable (such as a watch or glasses), appliance, internet of things (IoT) device, and/or projector, to name just a few examples. In some examples, media device 106 can be a part of, integrated with, operatively coupled to, and/or connected to its respective display device 108.

Each media device 106 may be configured to communicate with network 118 via a communication device 114. The communication device 114 may include, for example, a cable modem or satellite TV transceiver. The media device 106 may communicate with the communication device 114 over a link 116, wherein the link 116 may include wireless (such as WiFi) and/or wired connections.

In various examples, the network 118 can include, without limitation, wired and/or wireless intranet, extranet, Internet, cellular, Bluetooth, infrared, and/or any other short range, long range, local, regional, global communications mechanism, means, approach, protocol and/or network, as well as any combination(s) thereof.

Media system 104 may include a remote control 110. The remote control 110 can be any component, part, apparatus and/or method for controlling the media device 106 and/or display device 108, such as a remote control, a tablet, laptop computer, smartphone, wearable, on-screen controls, integrated control buttons, audio controls, or any combination thereof, to name just a few examples. In some examples, the remote control 110 wirelessly communicates with the media device 106 and/or display device 108 using cellular, Bluetooth, infrared, etc., or any combination thereof. The remote control 110 may include a microphone 112, which is further described below.

The multimedia environment 102 may include a plurality of content servers 120 (also called content providers, channels or sources 120). Although only one content server 120 is shown in FIG. 1, in practice the multimedia environment 102 may include any number of content servers 120. Each content server 120 may be configured to communicate with network 118.

Each content server 120 may store content 122 and metadata 124. Content 122 may include any combination of music, audio, videos, movies, TV programs, multimedia, images, still pictures, text, graphics, gaming applications, advertisements, programming content, public service content, government content, local community content, software, recording or live feed from a surveillance and security system, and/or any other content or data objects in electronic form.

In some configurations, a portion of content 122 (e.g., live media content) may include an advertisement that promotes or is otherwise associated with a product, service, business, brand, and/or event. For example, content 122 may include an advertisement, which is inserted within the live media content and to be displayed on a device (e.g., display device 108, media device 106, user device, client device, etc.).

The metadata 124 comprises data about content 122 (e.g., live media content capturing a live event). For example, metadata 124 may include associated or ancillary information indicating or related to a title or name of a live event broadcasted in content 122, a type, theme, or genre of the live event, a geographic location or region of the live event, a venue (e.g., stadium, studio, amphitheater, etc.) of the live event, purpose or format of the live event, participants in the live event (e.g., hosts, presenters, players, performers, guests, collaborators, etc.), statistics relating to the live event, progress of the live event, rules associated with the live event, technical specifications (e.g., video resolution, audio quality, streaming bitrate, encoding format, playback settings, etc.), accessibility features, data related to audience engagement and viewer metrics, sponsors of the live event, and/or any other information pertaining or relating to the content 122.

The multimedia environment 102 may include one or more system servers 126. The system servers 126 may operate to support the media devices 106 from the cloud. It is noted that the structural and functional aspects of the system servers 126 may wholly or partially exist in the same or different ones of the system servers 126.

The media devices 106 may exist in thousands or millions of media systems 104. Accordingly, the media devices 106 may lend themselves to crowdsourcing embodiments and, thus, the system servers 126 may include one or more crowdsource servers 128.

For example, using information received from the media devices 106 in the thousands and millions of media systems 104, the crowdsource server(s) 128 may identify similarities and overlaps between closed captioning requests issued by different users 132 watching a particular movie. Based on such information, the crowdsource server(s) 128 may determine that turning closed captioning on may enhance users' viewing experience at particular portions of the movie (for example, when the soundtrack of the movie is difficult to hear), and turning closed captioning off may enhance users' viewing experience at other portions of the movie (for example, when displaying closed captioning obstructs critical visual aspects of the movie). Accordingly, the crowdsource server(s) 128 may operate to cause closed captioning to be automatically turned on and/or off during future streamings of the movie.

The system servers 126 may also include an audio command processing system 130. As noted above, the remote control 110 may include a microphone 112. The microphone 112 may receive audio data from users 132 (as well as other sources, such as the display device 108). In some examples, the media device 106 may be audio responsive, and the audio data may represent verbal commands from the user 132 to control the media device 106 as well as other components in the media system 104, such as the display device 108.

In some examples, the audio data received by the microphone 112 in the remote control 110 is transferred to the media device 106, which is then forwarded to the audio command processing system 130 in the system servers 126. The audio command processing system 130 may operate to process and analyze the received audio data to recognize the user 132's verbal command. The audio command processing system 130 may then forward the verbal command back to the media device 106 for processing.

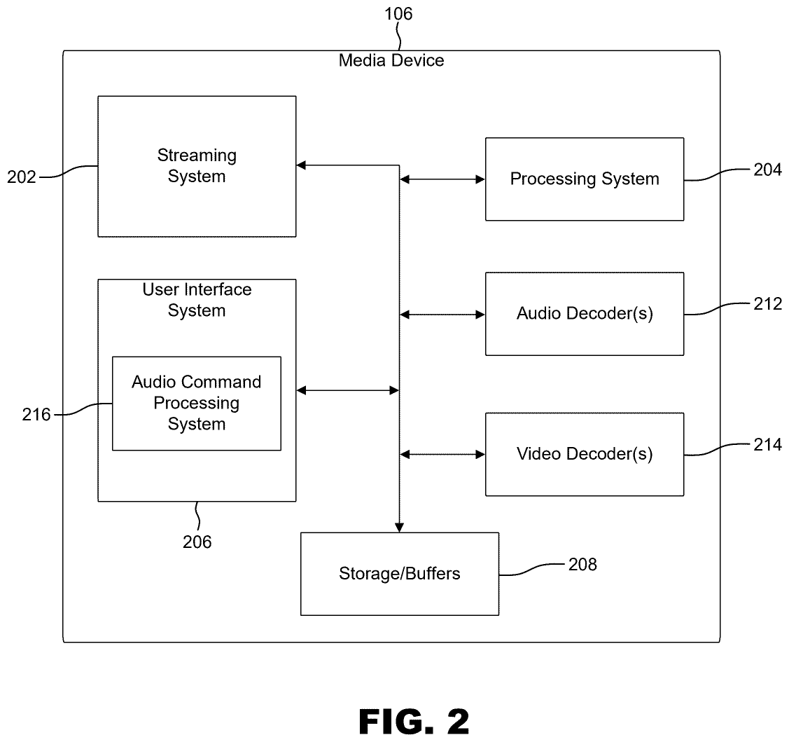

In some examples, the audio data may be alternatively or additionally processed and analyzed by an audio command processing system 216 in the media device 106 (see FIG. 2). The media device 106 and the system servers 126 may then cooperate to pick one of the verbal commands to process (either the verbal command recognized by the audio command processing system 130 in the system servers 126, or the verbal command recognized by the audio command processing system 216 in the media device 106).

FIG. 2 illustrates a block diagram of an example media device 106, according to some embodiments. Media device 106 may include a streaming system 202, processing system 204, storage/buffers 208, and user interface module 206. As described above, the user interface module 206 may include the audio command processing system 216.

The media device 106 may also include one or more audio decoders 212 and one or more video decoders 214. Each audio decoder 212 may be configured to decode audio of one or more audio formats, such as but not limited to AAC, HE-AAC, AC3 (Dolby Digital), EAC3 (Dolby Digital Plus), WMA, WAV, PCM, MP3, OGG GSM, VVC, FLAC, AU, AIFF, and/or VOX, to name just some examples.

Similarly, each video decoder 214 may be configured to decode video of one or more video formats, such as but not limited to MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmv, wma, asf), WEBM, FLV, AVI, QuickTime, HDV, MXF (OP1a, OP-Atom), MPEG-TS, MPEG-2 PS, MPEG-2 TS, WAV, Broadcast WAV, LXF, GXF, and/or VOB, to name just some examples. Each video decoder 214 may include one or more video codecs, such as but not limited to H.263, H.264, H.265, VVC, AVI, HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX, to name just some examples.

Now referring to both FIGS. 1 and 2, in some examples, the user 132 may interact with the media device 106 via, for example, the remote control 110. For example, the user 132 may use the remote control 110 to interact with the user interface module 206 of the media device 106 to select content, such as a movie, TV show, music, book, application, game, etc. The streaming system 202 of the media device 106 may request the selected content from the content server(s) 120 over the network 118. The content server(s) 120 may transmit the requested content to the streaming system 202. The media device 106 may transmit the received content to the display device 108 for playback to the user 132.

In streaming examples, the streaming system 202 may transmit the content to the display device 108 in real time or near real time as it receives such content from the content server(s) 120. In non-streaming examples, the media device 106 may store the content received from content server(s) 120 in storage/buffers 208 for later playback on display device 108.

### Subgraph Pattern Extraction

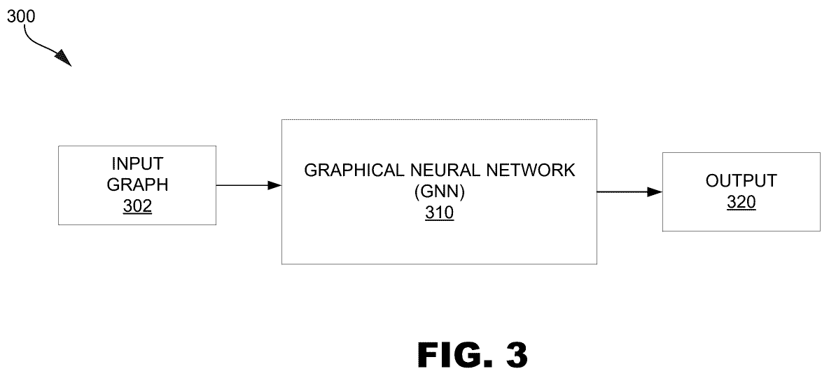

FIG. 3 illustrates an example system 300 for extracting subgraph patterns in graph-structured data using a graph neural network (GNN), according to some examples of the present disclosure. As illustrated, GNN 310 receives input graph 302 and generates output 320 (e.g., embeddings). In some examples, input graph 302 can include a plurality of nodes and edges that encode relationships among various entities, such as users, media content items, or contextual metadata. By way of example, input graph can include graph-structured data associated with media content 102.

As discussed above, the input graph 302 may be characterized by its large scale and sparse connectivity, a structure commonly observed in real-world datasets such as media consumption networks or user interaction graphs. In various implementations, the input graph 302 may encode a combination of content-related data and associated metadata, such as content 122 and metadata 124 described in FIG. 1. Additionally, the input graph 302 may incorporate user-specific information that reflects individual or collective behavior within a media ecosystem. This user data can include structured profile attributes, such as demographic information (e.g., age, gender, geographic location, income level, generational cohort, occupation), as well as behavioral signals including user preferences, privacy configurations, content viewing histories, search queries, and social engagement metrics derived from external platforms. The integration of this diverse data into a unified graph structure enables the graph neural network to model not only direct interactions between users and media items but also latent, higher-order relationships embedded in user behavior patterns and content affinity clusters.

In some implementations, GNN 310 is configured to identify and encode characteristic subgraph patterns within a graph-structured dataset. Specifically, GNN 310 operates by detecting the occurrence of predefined structural motifs (e.g., triangles, quadrangles, or cliques, etc.), within the input graph 302 and translating these patterns into numerical embeddings. The GNN is parameterized by a set of subgraph templates, or pattern graphs, which define the structural motifs of interest. For instance, in the context of a media recommendation system, input graph 302 may be a heterogeneous web graph composed of nodes representing users, media content items, channels, studios, or actors, and edges representing interactions or affiliations among these entities. For each node in the graph, GNN 310 computes localized neighborhoods and searches for rooted occurrences of the specified subgraph patterns. The resulting pattern-aware aggregations are then transformed into output 320, which comprises node embeddings enriched with information about the node's structural and relational context.

The GNN 310 may be implemented as a rooted graph homomorphism network parameterized by a pattern set P^{●} referred to herein as P^{●}-RGHN. The pattern set P^{●} includes small, rooted graph structures, such as 3-node triangles or 4-node cliques, that serve as the basis for local pattern detection. The P^{●}-RGHN model is typically composed of multiple layers, each responsible for aggregating information across instances of rooted homomorphisms. More formally, for each layer, the model enumerates rooted homomorphisms π that map a pattern P∈P^{●} into the local subgraph rooted at a node μ, preserving adjacency. For each such homomorphism, the model aggregates features from the participating nodes using learnable neural functions associated with each pattern. The following pseudo-code describes one such aggregation procedure, referred to as Algorithm [1].

### Algorithm [1] Inputs:

Let G=(V, E) be the input graph, with node feature vectors x[u] defined for all u∈V.
Let P denote a pattern graph with k nodes, and let nnP, nnP1, . . . , nnPk be neural networks associated with the pattern and its constituent positions.
1: for each node u1∈V
2: for each pattern P∈P⁵⁷⁴.
3: for all node tuples (u2, . . . , uk)∈V such that {u1, . . . , uk} forms a valid instance of pattern P
4: temp [u1]+=nnP1(x[u1])·nnP2(x[u2]) . . . nnPk (x[uk])
5: for each node u∈V
6: output [u]+=nnP(temp [u])

Various alternatives to the aggregation step on line 4 can be implemented. For example, a weighted exponential formulation such as exp(A1 x[u1]+ . . . +Ak x[uk]) may be used, where each Ai is a learnable weight matrix and nnPi(x)=exp(Ai x). Alternatively, a single joint neural function nnP(x[u1], . . . , x[uk]) may be applied to the full tuple of input features.

Algorithm [1] is computationally efficient for sparse graphs, as the outer loop over nodes scales linearly with the number of vertices. Furthermore, for certain patterns like quadrangles, dynamic programming techniques can be applied to accelerate the enumeration of matching subgraphs by reusing partial computations. The architecture is also compositional: arbitrary complex patterns can be constructed by composing smaller base patterns from the input pattern set P●.

Subgraph patterns extracted by the model may include triangles, quadrangles, and cliques-structures that commonly reflect community topology, repeated behavior, or tightly coupled relationships within the graph. These patterns are essential for capturing latent group dynamics, co-consumption tendencies, or role-based interactions. In some applications, the system may formulate a node classification task where the labels correspond to the presence or count of specific subgraph patterns rooted at each node. In such cases, GNN 310 learns to predict these labels by leveraging both the input node features and the structure of the surrounding graph, enabling pattern-aware supervision during training.

GNN 310 may be deployed within content server(s) 120 or media system 104 to support graph-based analytics in a streaming media environment. For example, the embeddings generated by GNN 310 can be used in search and recommendation systems to identify relevant content based on a user's embedding, which reflects not only the user's direct viewing history but also the higher-order structural context in which those interactions occur. This allows the recommendation engine to infer latent preferences or identify emerging viewing patterns across the user base, resulting in more precise and contextually informed recommendations.

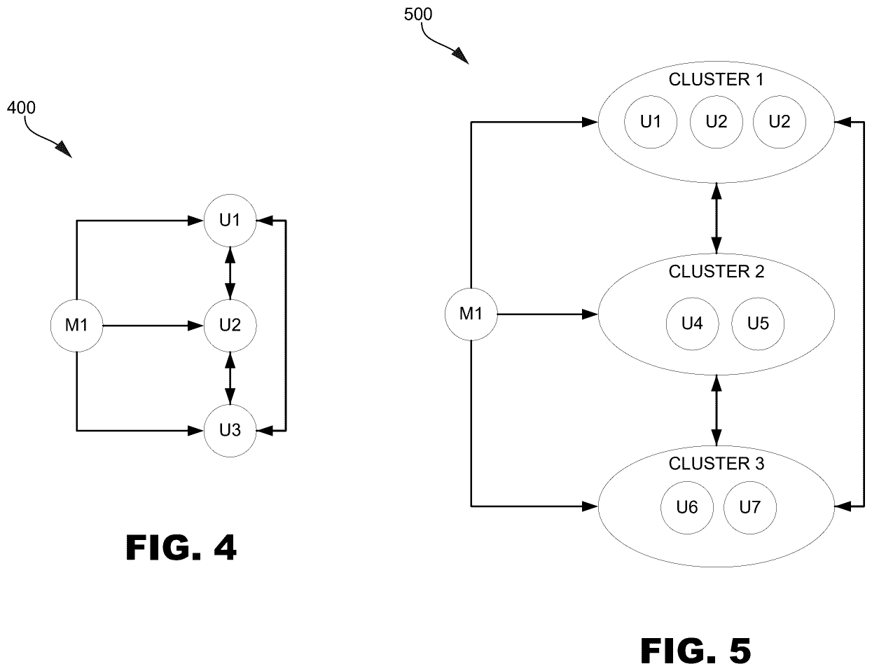

FIG. 4 is a diagram illustrating an example of a GNN architecture 400, according to some examples of the present disclosure. In FIG. 4, M1 denotes a node representing Media content 1 and U1, U2, U3 denote a node representing User 1, User 2, User 3, respectively. In this example, U1 has a habit (e.g., cycle) of watching M1 every Sunday. For example, GNN 310 can identify that U1 has a repeating pattern (P) of watching M1 every Sunday. That is, GNN 310 can capture this cycle structure in accordance with line 3 of Algorithm [1]. As follows, GNN 310 can output embeddings that include the cycle structure information (e.g., a pattern P).

Also, GNN 310 can determine the similarities between U1 and U2, for example based on user data (e.g., user demographics (e.g., age, sex, geographic location, income, generation, occupation, etc.), user preferences, a geographic region or location of the user/viewer or a location for streaming media content, privacy settings, viewing history or viewing patterns, search history, social media data representing social media activities, and so on). In some examples, U1, U2, and U3 can be accessed based on a Euclidean distance or distance metric to determine the subgraph pattern. In other examples, U1, U2, and U3 can be accessed based on a score (e.g., inner product, etc.) to determine the subgraph pattern. Based on the similarities between U1 and U2, it can be determined that U2 is likely to have the same pattern (e.g., cyclic behavior), and therefore, M1 can be recommended to U2 on Sunday.

While the example described with respect to FIG. 4 refer to user and media content nodes, a node can be any applicable person, place, or thing such as a channel, an actor, a studio, a media content item, etc. For example, GNN 310 can identify a subgraph pattern where a user switches between two channels periodically, which can be represented by 2 or 3 cycles.

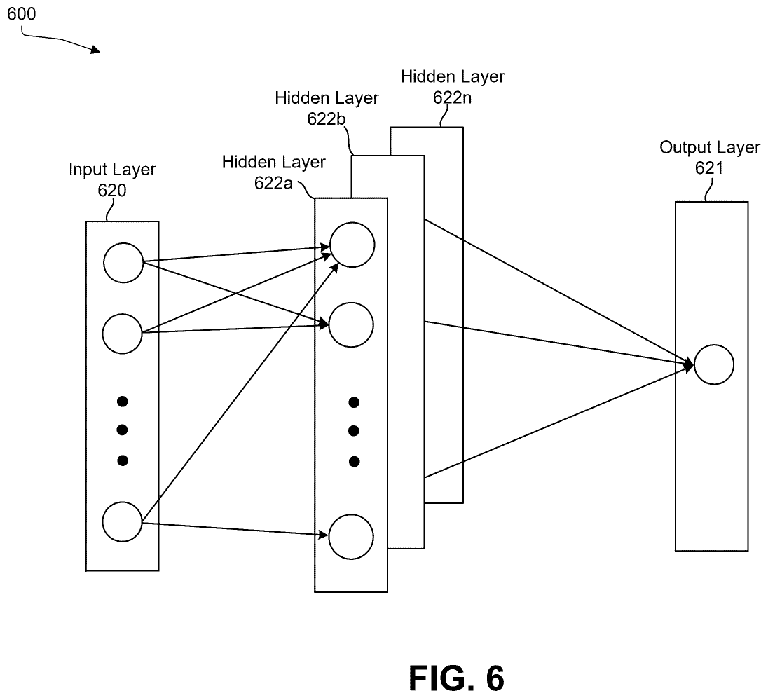

FIG. 5 is a diagram illustrating an example of a GNN architecture 500, according to some examples of the present disclosure. As shown, multiple users with similarities can be grouped as a cluster, for example, Cluster 1 that includes U1, U2, and U3, Cluster 2 that includes U4 and U5, and Cluster 3 that includes U6 and U7. In some examples, GNN 310 can encode the information across the users in the same cluster. For example, U1, U2, and U3 in Cluster 1 has the repeating pattern P with respect to M1. Cluster 2 and Cluster 3, which may share similarities with Cluster 1, are therefore predicted to have the same pattern P with respect to M1.

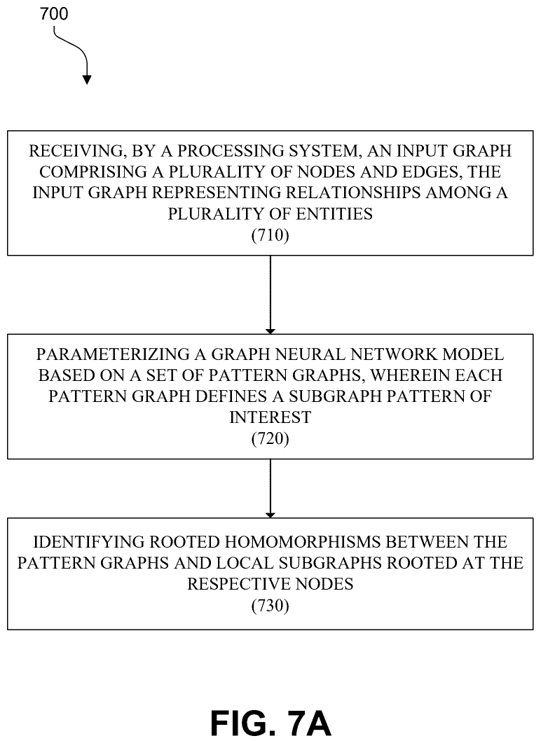

FIG. 6 is a diagram illustrating an example of a neural network architecture 600 that can be used to implement some or all of the neural networks described herein (e.g., GNN 310). The neural network architecture 600 can include an input layer 620 can be configured to receive and process data to generate one or more outputs. The neural network architecture 600 also includes hidden layers 622a, 622b, through 622n. The hidden layers 622a, 622b, through 622n include “n” number of hidden layers, where “n” is an integer greater than or equal to one. The number of hidden layers can be made to include as many layers as needed for the given application. The neural network architecture 600 further includes an output layer 621 that provides an output resulting from the processing performed by the hidden layers 622a, 622b, through 622n.

The neural network architecture 600 is a multi-layer neural network of interconnected nodes. Each node can represent a piece of information. Information associated with the nodes is shared among the different layers and each layer retains information as information is processed. In some cases, the neural network architecture 600 can include a feed-forward network, in which case there are no feedback connections where outputs of the network are fed back into itself. In some cases, the neural network architecture 600 can include a recurrent neural network, which can have loops that allow information to be carried across nodes while reading in input.

Information can be exchanged between nodes through node-to-node interconnections between the various layers. Nodes of the input layer 620 can activate a set of nodes in the first hidden layer 622a. For example, as shown, each of the input nodes of the input layer 620 is connected to each of the nodes of the first hidden layer 622a. The nodes of the first hidden layer 622a can transform the information of each input node by applying activation functions to the input node information. The information derived from the transformation can then be passed to and can activate the nodes of the next hidden layer 622b, which can perform their own designated functions. Example functions include convolutional, up-sampling, data transformation, and/or any other suitable functions. The output of the hidden layer 622b can then activate nodes of the next hidden layer, and so on. The output of the last hidden layer 622n can activate one or more nodes of the output layer 621, at which an output is provided. In some cases, while nodes in the neural network architecture 600 are shown as having multiple output lines, a node can have a single output and all lines shown as being output from a node represent the same output value.

In some cases, each node or interconnection between nodes can have a weight that is a set of parameters derived from the training of the neural network architecture 600. Once the neural network architecture 600 is trained, it can be referred to as a trained neural network, which can be used to generate one or more outputs. For example, an interconnection between nodes can represent a piece of information learned about the interconnected nodes. The interconnection can have a tunable numeric weight that can be tuned (e.g., based on a training dataset), allowing the neural network architecture 600 to be adaptive to inputs and able to learn as more and more data is processed.

The neural network architecture 600 is pre-trained to process the features from the data in the input layer 620 using the different hidden layers 622a, 622b, through 622n in order to provide the output through the output layer 621.

In some cases, the neural network architecture 600 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network architecture 600 is trained well enough so that the weights of the layers are accurately tuned.

To perform training, a loss function can be used to analyze an error in the output. Any suitable loss function definition can be used, such as a Cross-Entropy loss. Another example of a loss function includes the mean squared error (MSE), defined as E_total=Σ(½ (target-output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network architecture 600 can perform a backward pass by determining which inputs (weights) most contributed to the loss of the network, and can adjust the weights so that the loss decreases and is eventually minimized.

The neural network architecture 600 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network architecture 600 can include any other deep network other than a CNN, such as an autoencoder, Deep Belief Nets (DBNs), Recurrent Neural Networks (RNNs), among others.

As understood by those of skill in the art, machine-learning based techniques can vary depending on the desired implementation. For example, machine-learning schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

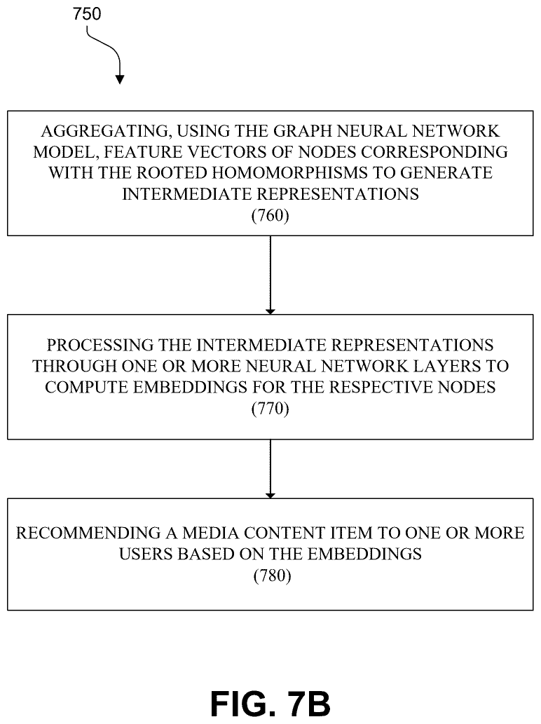

FIG. 7A illustrates an example process for identifying rooted homomorphisms between one or more pattern graphs and one or more local subgraphs, according to some aspects of the disclosed technology. At block 710, the system receives an input graph comprising a plurality of nodes and edges. This graph can be representative of relational data between a plurality of entities. For example, in a media recommendation context, the graph may include nodes representing users, media items (e.g., movies or shows), and other entities such as channels, actors, and/or advertisers, etc. Edges may represent interactions or relationships between those entities, such as a user watching a movie, or two users viewing the same content.

At block 720, the system parameterizes a GNN model based on a predefined set of pattern graphs. Each pattern graph defines a characteristic subgraph structure or motif that is of analytical interest. These pattern graphs may include triangles (indicative of co-viewing or shared affinities), quadrangles (e.g., cross-cluster interactions or sequential patterns), cliques (dense user engagement), or cycles (periodic behavior, such as repeated viewing). The model uses these patterns to guide the structure of information aggregation, enabling the GNN to focus on higher-order topological signals rather than just pairwise edges. This parameterization allows the GNN to go beyond standard message-passing mechanisms—which typically rely on 1-hop or 2-hop neighbor aggregation—by leveraging localized higher-order structure information. As a result, the GNN can capture nuanced patterns such as repeated co-engagements (e.g., user-item-item triangles indicating series consumption), shared structural roles (e.g., users embedded in similar motifs), and/or behavioral motifs (e.g., cycles representing periodic interactions), and encode them into expressive node embeddings.

The inclusion of these patterns as inductive biases can significantly enhance the model's expressive power, particularly on sparse graphs with rich but distributed structural signals. Moreover, since the pattern graphs are fixed and small, the corresponding computations are optimized to run in linear or near-linear time with respect to the size of the input graph when bounded-degree or bounded-degeneracy assumptions hold. This makes the parameterized model scalable for large-scale graph learning tasks.

At block 730, the system identifies rooted homomorphisms between the pattern graphs and subgraphs within the input graph that are rooted at specific nodes. A rooted homomorphism is a structure-preserving mapping from a pattern graph to a local subgraph, such that the adjacency relationships within the pattern are preserved in the mapped subgraph. For each node in the input graph, the system searches its local neighborhood to determine whether any of the predefined patterns can be matched. These matches form the basis for the model's embeddings, allowing it to encode the presence, frequency, and type of subgraph motifs associated with each node.

This process enables the system to extract meaningful structural features from complex relational data, which can subsequently be used for downstream tasks such as node classification, user behavior prediction, recommendation ranking, or anomaly detection. The use of rooted homomorphisms allows for efficient and expressive modeling of relational context, enabling the system to outperform conventional message-passing GNNs that lack the ability to distinguish such higher-order patterns.

FIG. 7B illustrates an example process 750 that describes the inference and application phase of a graph neural network (GNN) model trained to detect and encode higher-order subgraph patterns using rooted homomorphisms. This process continues from the subgraph pattern extraction and parameterization steps shown in FIG. 7A, and details how intermediate graph representations are transformed into actionable outputs, such as personalized media content recommendations.

In block 760, the system performs an aggregation of feature vectors from nodes in the input graph that correspond to rooted homomorphisms previously identified between a set of pattern graphs and local subgraphs. For each node in the input graph, the model enumerates all valid rooted homomorphisms from the selected pattern set (e.g., triangle, quadrangle, clique, etc.) that map the root of the pattern graph to the node in question.

In block 770, the intermediate representations are passed through one or more neural network layers to compute final embeddings for the respective nodes. The embeddings learned at this stage encapsulate both the local structural role of a node (e.g., user or media item) and the patterns it participates in, which can reflect community membership, shared behavioral motifs, or recurring viewing sequences. For example, two users that are consistently embedded in triangle patterns with similar sets of media items may receive similar embeddings, despite differences in raw feature space.

In block 780, the computed embeddings are used to drive personalized content recommendations. Alternatively, a downstream recommendation model (e.g., a matrix factorization or two-tower neural model) may consume the embeddings to predict top-k items likely to be of interest to a given user. For instance, if a user's embedding places them in a cluster of other users that exhibit cyclic co-engagement with a particular series of movies, the system may recommend the next unwatched item in that series. Similarly, users whose embeddings are structurally proximate to others who recently engaged with a new content item may be targeted for early exposure or marketing of that item.

In other aspects, the computed embeddings may be used for other applications, such as audience segmentation in which each embedding can be used to encode a user's local graph context. In such cases, the embedding vectors can be analyzed using clustering algorithms such as k-means or DBSCAN to group users with similar patterns of interaction. For example, one cluster might contain users whose embeddings indicate frequent presence in triangle motifs with action movies and a particular set of actors, suggesting a preference for fast-paced, genre-specific content. Another cluster might contain users embedded in cyclic patterns involving family movies, reflecting habitual group viewing at certain times of day or week.

Once clustered, these groups can be used to deliver targeted advertising, where different clusters receive different ad categories or creative content. They can also inform strategic content decisions, such as the scheduling of premieres and/or recommendations that align with the viewing behaviors typical of each group. In cases where individual-level personalization is computationally costly, these clusters can also serve as a foundation for applying recommendations or user interface customizations across broader user segments, enabling more scalable personalization efforts.

### Example Computer System

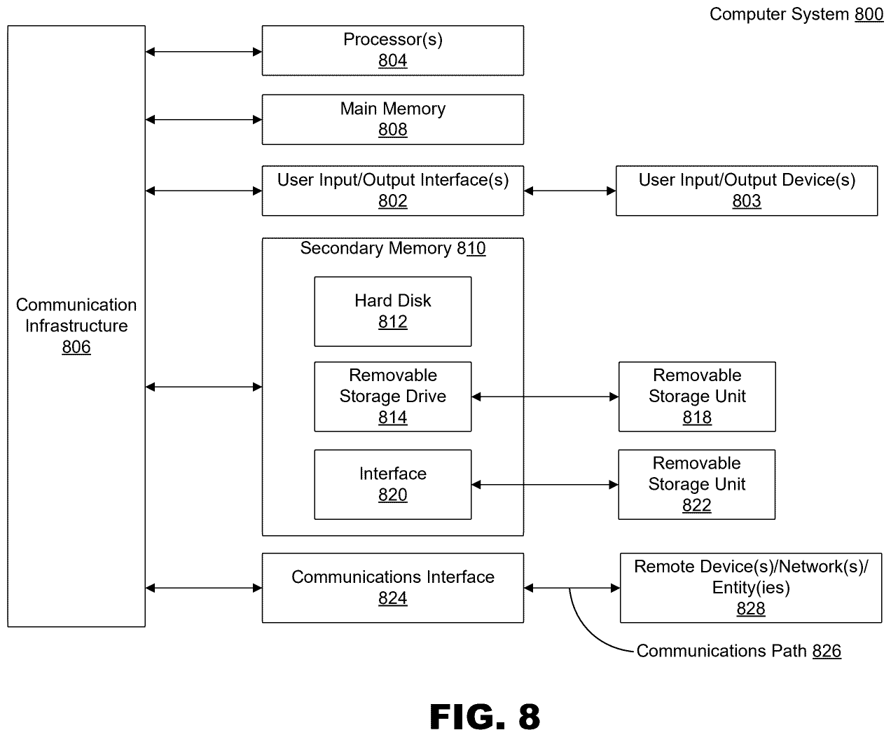

Various aspects and examples may be implemented, for example, using one or more well-known computer systems, such as computer system 800 shown in FIG. 8. For example, the media device 106 may be implemented using combinations or sub-combinations of computer system 800. Also or alternatively, one or more computer systems 800 may be used, for example, to implement any of the aspects and examples discussed herein, as well as combinations and sub-combinations thereof.

Computer system 800 may include one or more processors (also called central processing units, or CPUs), such as a processor 804. Processor 804 may be connected to a communication infrastructure or bus 806. Computer system 800 may also include user input/output device(s) 803, such as monitors, keyboards, pointing devices, etc., which may communicate with communication infrastructure 806 through user input/output interface(s) 802. One or more of processors 804 may be a graphics processing unit (GPU). In some examples, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 800 may also include a main or primary memory 808, such as random access memory (RAM). Main memory 808 may include one or more levels of cache. Main memory 808 may have stored therein control logic (e.g., computer software) and/or data.

Computer system 800 may also include one or more secondary storage devices or memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage unit 818. Removable storage unit 818 may include a computer usable or readable storage device having stored thereon computer software (control logic) and/or data. Removable storage unit 818 may be a floppy disk, magnetic tape, compact disk, DVD, optical storage disk, and/any other computer data storage device. Removable storage drive 814 may read from and/or write to removable storage unit 818.

Secondary memory 810 may include other means, devices, components, instrumentalities or other approaches for allowing computer programs and/or other instructions and/or data to be accessed by computer system 800. Such means, devices, components, instrumentalities or other approaches may include, for example, a removable storage unit 822 and an interface 820.

Examples of the removable storage unit 822 and the interface 820 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 800 may include a communication or network interface 824. Communication interface 824 may enable computer system 800 to communicate and interact with any combination of external devices, external networks, external entities, etc. (individually and collectively referenced by reference number 828). For example, communication interface 824 may allow computer system 800 to communicate with external or remote devices 828 over communications path 826, which may be wired and/or wireless (or a combination thereof), and which may include any combination of LANs, WANs, the Internet, etc. Control logic and/or data may be transmitted to and from computer system 800 via communications path 826.

Computer system 800 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 800 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 800 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some examples, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 800, main memory 808, secondary memory 810, and removable storage units 818 and 822, as well as tangible articles of manufacture embodying any combination of the foregoing. Such control logic, when executed by one or more data processing devices (such as computer system 800 or processor(s) 804), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 8. In particular, embodiments can operate with software, hardware, and/or operating system implementations other than those described herein.

### CONCLUSION

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still cooperate or interact with each other.

The breadth and scope of this disclosure should not be limited by any of the above-described exemplary embodiments, but should be defined only in accordance with the following claims and their equivalents.

Depending on the desired implementation, the invention may include any of the following aspects:

Aspect 1. A computer-implemented method for extracting subgraph patterns from graph-structured data, the method comprising: receiving, by a processing system, an input graph comprising a plurality of nodes and edges, the input graph representing relationships among a plurality of entities; parameterizing a graph neural network model based on a set of pattern graphs, wherein each pattern graph defines a subgraph pattern of interest; and identifying, for at least a portion of the nodes in the input graph, rooted homomorphisms between the pattern graphs and local subgraphs rooted at the respective nodes, wherein the rooted homomorphisms preserve adjacency relationships of the pattern graphs.

Aspect 2. The computer-implemented method of Aspect 1, further comprising: aggregating, using the graph neural network model, feature vectors of nodes corresponding with the rooted homomorphisms to generate intermediate representations; and processing the intermediate representations through one or more neural network layers to compute embeddings for the respective nodes, wherein the embeddings encode information indicative of subgraph pattern occurrences in the input graph.

Aspect 3. The computer-implemented method of Aspect 2, further comprising: recommending a media content item to one or more users based on the embeddings.

Aspect 4. The computer-implemented method of any of Aspects 2 to 3, further comprising: predicting a behavior of one or more users based on the embeddings.

Aspect 5. The computer-implemented method of any of Aspects 2 to 4, further comprising: determining a search ranking based on the embeddings.

Aspect 6. The computer-implemented method of any of Aspects 1 to 5, wherein the plurality of entities comprises one or more users and one or more media content items.

Aspect 7. The computer-implemented method of any of Aspects 1 to 6, wherein the set of pattern graphs includes a triangle, a quadrangle, a clique, a cycle structure, or a combination thereof.

Aspect 8. An system comprising: at least one memory; and at least one processor coupled to the at least one memory, the at least one processor configured to perform operations for: receiving, by a processing system, an input graph comprising a plurality of nodes and edges, the input graph representing relationships among a plurality of entities; parameterizing a graph neural network model based on a set of pattern graphs, wherein each pattern graph defines a subgraph pattern of interest; and identifying, for at least a portion of the nodes in the input graph, rooted homomorphisms between the pattern graphs and local subgraphs rooted at the respective nodes, wherein the rooted homomorphisms preserve adjacency relationships of the pattern graphs.

Aspect 9. The system of Aspect 8, wherein the at least one processor is further configured to perform operations for: aggregating, using the graph neural network model, feature vectors of nodes corresponding with the rooted homomorphisms to generate intermediate representations; and processing the intermediate representations through one or more neural network layers to compute embeddings for the respective nodes, wherein the embeddings encode information indicative of subgraph pattern occurrences in the input graph.

Aspect 10. The system of any of Aspects 9, wherein the at least one processor is further configured to perform operations for: recommending a media content item to one or more users based on the embeddings.

Aspect 11. The system of any of Aspects 9 to 10, wherein the at least one processor is further configured to perform operations for: predicting a behavior of one or more users based on the embeddings.

Aspect 12. The system of any of Aspects 9 to 11, wherein the at least one processor is further configured to perform operations for: determining a search ranking based on the embeddings.

Aspect 13. The system of any of Aspects 9 to 12, wherein the plurality of entities comprises one or more users and one or more media content items.

Aspect 14. The system of any of Aspects 9 to 13, wherein the set of pattern graphs includes a triangle, a quadrangle, a clique, a cycle structure, or a combination thereof.

Aspect 15. A non-transitory computer-readable storage medium comprising at least one instruction for causing a computer or processor to: receive an input graph comprising a plurality of nodes and edges, the input graph representing relationships among a plurality of entities; parameterize a graph neural network model based on a set of pattern graphs, wherein each pattern graph defines a subgraph pattern of interest; and identify, for at least a portion of the nodes in the input graph, rooted homomorphisms between the pattern graphs and local subgraphs rooted at the respective nodes, wherein the rooted homomorphisms preserve adjacency relationships of the pattern graphs.

Aspect 16. The non-transitory computer-readable storage medium of Aspect 15, wherein the at least one instruction is further configured to cause the computer or processor to: aggregate, using the graph neural network model, feature vectors of nodes corresponding with the rooted homomorphisms to generate intermediate representations; and process the intermediate representations through one or more neural network layers to compute embeddings for the respective nodes, wherein the embeddings encode information indicative of subgraph pattern occurrences in the input graph.

Aspect 17. The non-transitory computer-readable storage medium of any of Aspects 15 to 16, wherein the at least one instruction is further configured to cause the computer or processor to: recommend a media content item to one or more users based on the embeddings.

Aspect 18. The non-transitory computer-readable storage medium of any of Aspects 15 to 17, wherein the at least one instruction is further configured to cause the computer or processor to: predict a behavior of one or more users based on the embeddings.

Aspect 19. The non-transitory computer-readable storage medium of any of Aspects 15 to 18, wherein the at least one instruction is further configured to cause the computer or processor to: determine a search ranking based on the embeddings.

Aspect 20. The non-transitory computer-readable storage medium of any of Aspects 15 to 19, wherein the plurality of entities comprises one or more users and one or more media content items.

Aspect 21. The computer-implemented method of any of Aspects 2 to 20, wherein the graph neural network model applies a distinct aggregation function for each type of pattern graph in the set of pattern graphs.

Aspect 22. The computer-implemented method of any of Aspects 2 to 21, wherein the embeddings are used as input to a downstream machine learning model configured to predict user churn or engagement levels.

Aspect 23. The computer-implemented method of any of Aspects 2 to 22, wherein the input graph comprises edges labeled with interaction metadata, and the parameterization of the graph neural network model is conditioned on said edge labels.

Aspect 24. The computer-implemented method of any of Aspects 2 to 23, wherein each rooted homomorphism is associated with a confidence score computed by a neural submodule, and the score is used to weight its contribution to the intermediate representation.

Aspect 25. The computer-implemented method of any of Aspects 2 to 24, wherein the set of pattern graphs includes domain-specific motifs selected from prior analysis of historical user-media interaction data.

Aspect 26. The computer-implemented method of any of Aspects 2 to 25, wherein the graph neural network model is trained using supervised labels derived from historical media consumption outcomes, including user ratings or completion rates.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A computer-implemented method for extracting subgraph patterns from graph-structured data, the method comprising:
receiving, by a processing system, an input graph comprising a plurality of nodes and edges, the input graph representing relationships among a plurality of entities;
parameterizing a graph neural network model based on a set of pattern graphs, wherein each pattern graph defines a subgraph pattern of interest; and
identifying, for at least a portion of the nodes in the input graph, rooted homomorphisms between the pattern graphs and local subgraphs rooted at the respective nodes, wherein the rooted homomorphisms preserve adjacency relationships of the pattern graphs.

2. The computer-implemented method of claim 1, further comprising:
aggregating, using the graph neural network model, feature vectors of nodes corresponding with the rooted homomorphisms to generate intermediate representations; and
processing the intermediate representations through one or more neural network layers to compute embeddings for the respective nodes, wherein the embeddings encode information indicative of subgraph pattern occurrences in the input graph.

3. The computer-implemented method of claim 2, further comprising:
recommending a media content item to one or more users based on the embeddings.

4. The computer-implemented method of claim 2, further comprising:
predicting a behavior of one or more users based on the embeddings.

5. The computer-implemented method of claim 2, further comprising:
determining a search ranking based on the embeddings.

6. The computer-implemented method of claim 1, wherein the plurality of entities comprises one or more users and one or more media content items.

7. The computer-implemented method of claim 1, wherein the set of pattern graphs includes a triangle, a quadrangle, a clique, a cycle structure, or a combination thereof.

8. An apparatus comprising:
at least one memory; and
at least one processor coupled to the at least one memory, the at least one processor configured to perform operations for:
receiving, by a processing system, an input graph comprising a plurality of nodes and edges, the input graph representing relationships among a plurality of entities;
parameterizing a graph neural network model based on a set of pattern graphs, wherein each pattern graph defines a subgraph pattern of interest; and
identifying, for at least a portion of the nodes in the input graph, rooted homomorphisms between the pattern graphs and local subgraphs rooted at the respective nodes, wherein the rooted homomorphisms preserve adjacency relationships of the pattern graphs.

9. The system of claim 8, wherein the at least one processor is further configured to perform operations for:
aggregating, using the graph neural network model, feature vectors of nodes corresponding with the rooted homomorphisms to generate intermediate representations; and
processing the intermediate representations through one or more neural network layers to compute embeddings for the respective nodes, wherein the embeddings encode information indicative of subgraph pattern occurrences in the input graph.

10. The system of claim 9, wherein the at least one processor is further configured to perform operations for:
recommending a media content item to one or more users based on the embeddings.

11. The system of claim 9, wherein the at least one processor is further configured to perform operations for:
predicting a behavior of one or more users based on the embeddings.

12. The system of claim 9, wherein the at least one processor is further configured to perform operations for:
determining a search ranking based on the embeddings.

13. The system of claim 9, wherein the plurality of entities comprises one or more users and one or more media content items.

14. The system of claim 9, wherein the set of pattern graphs includes a triangle, a quadrangle, a clique, a cycle structure, or a combination thereof.

15. A non-transitory computer-readable storage medium comprising at least one instruction for causing a computer or processor to:
receive an input graph comprising a plurality of nodes and edges, the input graph representing relationships among a plurality of entities;
parameterize a graph neural network model based on a set of pattern graphs, wherein each pattern graph defines a subgraph pattern of interest; and
identify, for at least a portion of the nodes in the input graph, rooted homomorphisms between the pattern graphs and local subgraphs rooted at the respective nodes, wherein the rooted homomorphisms preserve adjacency relationships of the pattern graphs.

16. The non-transitory computer-readable storage medium of claim 15, wherein the at least one instruction is further configured to cause the computer or processor to:
aggregate, using the graph neural network model, feature vectors of nodes corresponding with the rooted homomorphisms to generate intermediate representations; and
process the intermediate representations through one or more neural network layers to compute embeddings for the respective nodes, wherein the embeddings encode information indicative of subgraph pattern occurrences in the input graph.

17. The non-transitory computer-readable storage medium of claim 15, wherein the at least one instruction is further configured to cause the computer or processor to:
recommend a media content item to one or more users based on the embeddings.

18. The non-transitory computer-readable storage medium of claim 15, wherein the at least one instruction is further configured to cause the computer or processor to:
predict a behavior of one or more users based on the embeddings.

19. The non-transitory computer-readable storage medium of claim 15, wherein the at least one instruction is further configured to cause the computer or processor to:
determine a search ranking based on the embeddings.

20. The non-transitory computer-readable storage medium of claim 15, wherein the plurality of entities comprises one or more users and one or more media content items.
